(19) United States
(12) Patent Application Publication
(10) Pub. No.: US 2009/0189586 A1
(43) Pub. Date: Jul. 30, 2009

(54) SWITCHED-CAPACITOR SOFT-START RAMP CIRCUITS

(76) Inventor: Kee Chee Tiew, Richardson, TX (US)

Correspondence Address: TEXAS INSTRUMENTS INCORPORATED, P O BOX 655474, M/S 3999, DALLAS, TX, 75265, US

(21) Appl. No.: 12/020,030

(22) Filed: Jan. 25, 2008

(51) Int. Cl. G05F 1/56

(52) U.S. Cl. 323/288

(57) ABSTRACT

Methods and apparatus for a switched-capacitor soft-start ramp generator circuit are described. In an example, an apparatus to provide a soft-start voltage is described, comprising a first capacitor, a feedback circuit to increase a reference voltage based on an output voltage, a second capacitor, having a capacitance value greater than a capacitance value of the first capacitor, a first device to couple and decouple the first capacitor to the reference voltage and a second device to couple and decouple the first capacitor to the second capacitor.

### FIELD OF THE DISCLOSURE

This disclosure relates generally to soft-start ramp circuits and, more particularly, to switched-capacitor soft-start ramp circuits.

### BACKGROUND

A circuit board may include many discrete and/or integrated circuits powered from a single voltage supply (e.g., 1.8V, 3.3V, and/or 5.0V). When a circuit first powers up, it may have a low input impedance and, consequently, may draw a large amount of current from a power supply for a very short period of time. Such a large initial current draw may cause the power supply, which may be powering other circuits, to suffer a significant voltage sag or drop that can cause undesirable effects on other circuits connected to the power supply. To prevent a power supply voltage drop caused by a large initial current draw, designers implement soft-start circuits to slowly increase the voltage to a circuit or device being powered up. Such circuits reduce the voltage provided to a device when that device is in a low input impedance mode due to startup and, thus, reduces current draw by the device and the attendant possible power supply voltage drop.

### BRIEF DESCRIPTION OF THE DRAWINGS

FIG. 1 is a schematic diagram of a known capacitor-divider based soft-start ramp generator.

FIG. 2 is a schematic diagram illustrating an example disclosed switched-capacitor soft-start ramp generator circuit.

FIG. 3 is a graph illustrating a voltage-time relationship for the circuits of FIGS. 1 and 2.

FIG. 4 is a flowchart illustrating an example process to provide a circuit with a switched-capacitor soft-start ramp.

### DETAILED DESCRIPTION

Certain examples are shown in the above-identified figures and described in detail below. In describing these examples, like or identical reference numbers may be used to identify common or similar elements. The figures are not necessarily to scale and certain features and certain views of the figures may be shown exaggerated in scale or in schematic for clarity and/or conciseness. Although the following discloses example methods and apparatus, it should be noted that such methods and apparatus are merely illustrative and should not be considered as limiting. The example circuits described herein may be implemented using discrete components, integrated circuits (ICs), or any combination thereof.

Additionally, it is contemplated that any form of logic may be used to implement portions of apparatus or methods herein. Logic may include, for example, circuit implementations that are made exclusively in dedicated hardware (e.g., circuits, transistors, logic gates, hard-coded processors, programmable array logic (PAL), application-specific integrated circuits (ASICs), etc.), exclusively in software, exclusively in firmware, or some combination of hardware, firmware, and/or software. Accordingly, while the following describes example methods and apparatus, persons of ordinary skill in the art will readily appreciate that the examples are not the only way to implement such apparatus.

As described in detail below, the examples described herein may be used to provide switched-capacitor soft-start ramp generator circuits that provide power to a circuit. Such example circuits increase supply voltage provided to a circuit or device being powered up to reduce the likelihood that the power supply voltages may sag during current drain of the circuit or device while the same is initially powered. According to a first example, a first capacitor is selectively coupled to a reference voltage or an output by switches. In one example, the switches are alternated between closed and open states based on a clock signal. The output provides feedback that affects a reference voltage via a feedback circuit utilizing a device, such as, for example, a p-type metal-oxide semiconductor (PMOS), which is forced to operate in the saturation region by a current source. The current source and PMOS may be adjusted so that the reference voltage is slightly higher than the output voltage. Thus, on a subsequent clock cycle the output voltage will be increased to the reference voltage and the reference voltage will again be increased. Thus, while the circuit being powered is coming on line, the supply voltage provided thereto steadily increases. The resulting example output to the circuit being powered is, therefore, a series of substantially equal increasing voltage steps, as described below.

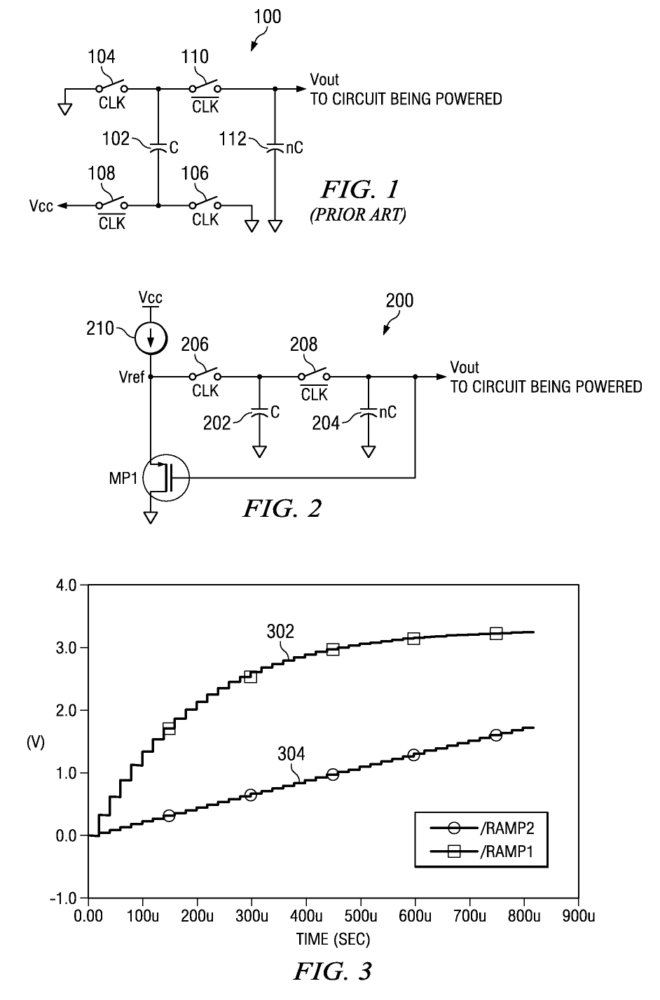

FIG. 1 is a schematic diagram of a known capacitor-divider based soft-start ramp generator 100. Terminals of a first capacitor 102, also referred to as a bucket capacitor, having a first capacitance value is selectively coupled to a supply voltage (Vcc) and an output voltage Vout and ground. Switches 104, 106, 108 and 110 are controlled by alternating clock signals CLK and C̅L̅K̅, where C̅L̅K̅ is the inverse signal of CLK. Switches 104 and 106 are closed and switches 108 and 110 are open when the CLK signal is high, coupling both terminals of the bucket capacitor 102 to ground and discharging energy from the bucket capacitor 102. On the next half clock cycle, switches 104 and 106 open and switches 108 and 110 close when the CLK signal is low and C̅L̅K̅ is high, which couples the bucket capacitor 102 in series between Vcc and Vout. As the bucket capacitor 102 charges, a second capacitor 112 (also referred to as an output capacitor) having a capacitance value larger than the capacitance value of the bucket capacitor 102 is charged, thereby increasing the output voltage by a small amount. The CLK signal (and, thus, the C̅L̅K̅ signal) repeats the switching behavior iteratively until Vout is equal or substantially equal to Vcc.

As the soft-start ramp generator 100 begins increasing the voltage to Vout, each iteration of the CLK signal produces a small increase in the voltage at Vout. Due to the charging behavior of the capacitors 102 and 112, the voltage increase to Vout is largest during the first iteration and increases by a smaller amount at each successive iteration. This creates an RC-like charging behavior for the soft-start ramp generator 100 as shown by the trace 302 in FIG. 3.

FIG. 2 is a schematic diagram illustrating an example disclosed switched-capacitor soft-start ramp generator circuit 200. The example soft-start ramp circuit 200 has a voltage source (Vcc) and ramps up an output voltage (Vout), which provides a voltage to a voltage regulator circuit (not shown). A first capacitor 202 (e.g., a bucket capacitor) is selectively coupled between a reference voltage Vref and an second capacitor 204 (e.g., an output capacitor) by switches 206 and 208. The switch 206 is closed when a CLK signal is active (e.g., high) and the switch 208 is closed when a C̅L̅K̅ signal is active.

In the example of FIG. 2, the capacitors 202 and 204 are implemented using polysilicon capacitors. However, the capacitors 202 and 204 may be implemented using any type of capacitor. Example types may include, but are not limited to, vacuum capacitors, ceramic capacitors, aluminum or tantalum electrolytic capacitors, metalized plastic film capacitors, and/or glass capacitors.

Additionally, although the example circuit 200 is shown having one bucket capacitor and one output capacitor, the bucket capacitor 202 and/or the output capacitor 204 may be implemented using more than one capacitor. For example, to achieve a particular capacitance ratio it may be necessary to place capacitors in parallel or series. This may be a desirable technique to use if, for example, inexpensive, commercially available capacitors with only a limited number of choices for capacitance values are used.

In the example of FIG. 2, CLK and C̅L̅K̅ are periodic signals such as, for example, the output of a crystal clock or an oscillator circuit. Another example implementation for the CLK and C̅L̅K̅ signals may be to generate C̅L̅K̅ from the output of an inverter circuit having CLK as the input. However, CLK and/or C̅L̅K̅ may be implemented using any periodic, aperiodic or manual signal.

The switches 206 and 208 as described in the example of FIG. 2 are complementary N-MOS and P-MOS transistors, which are coupled at the gates such that one signal is applied to both gates. Alternatively, the switches 206 and/or 208 may be implemented using any type of electrical or mechanical switching element. Example types of electrical or mechanical switching elements may include, but are not limited to, bipolar junction transistors, field-effect transistors, contactors and/or actuators.

In the example circuit 200 of FIG. 2, the current source 210 is implemented using a PMOS transistor. A gate of the PMOS transistor is connected to a bias voltage such that a constant current flows through the transistor. Alternatively, the current source 210 may be implemented using any circuit or technique to maintain a constant current over a range of voltages or provide a direct current bias.

Although the feedback circuit is shown using MP1 and the current source 210, any suitable circuit may be used to provide feedback from Vout to Vref. The goal of said feedback circuit is to keep the voltage of Vref slightly above the voltage of Vout during supply ramping.

Prior to powering up the load circuit(s), Vref and Vout exist at a steady state. Feedback is provided from Vout to Vref via a feedback circuit, which, when activated, causes Vref to have a slightly higher voltage than Vout. In the example circuit 200 of FIG. 2, the feedback circuit is implemented using a PMOS transistor (MP1) and a current source 210. The current source 210 is configured to force a small current to flow between the source-drain terminals of MP1, resulting in a small source-gate voltage at MP1. Prior to powering up the load circuit(s), the example feedback circuit is not active.

At initial startup of the load circuit(s) (i.e., the load circuit(s) is/are first coupled to the output of the circuit 200), the capacitor 202 may be coupled to one of Vref or Vout via switches 206 and 208. The feedback circuit (i.e., the current source 210 and PMOS MP1) is activated, causing a small rise in the voltage at Vref relative to Vout.

To start a first switching cycle and increase the voltage at Vout, the switch 206 is closed (if necessary) and switch 208 is opened (if necessary) to couple the capacitor 202 to Vref. While switch 206 is closed, Vref charges the capacitor 202 to the voltage at Vref. As described above, owing to the feedback circuit (MP1 and 210), Vref has a slightly higher voltage than Vout.

Next, switch 206 opens and switch 208 closes, allowing the capacitor 202 to discharge, which increases the voltage at Vout and charges a second capacitor 204 (e.g., an output capacitor). As Vout increases, it provides feedback to MP1. As mentioned above, the example current source 210 forces a small amount of current through the source-drain terminals of MP1, which causes MP1 to operate in the saturation region, resulting in a small source-gate voltage at MP1. Vref responds to the increase in Vout by increasing due to the source-gate voltage of MP1, which remains the same or substantially the same, that is added to the value of Vout. Thus, the next time the switch 206 closes and the switch 208 opens, the capacitor 202 is again charged with a voltage Vref slightly higher than Vout. As the voltage at Vref increases, the source-drain voltage of MP1 also increases, causing MP1 to operate in saturation. In this way, Vout is increased in equal or substantially equal voltage steps with each cycle of the CLK and C̅L̅K̅ signals.

As the operation of the circuit 200 iterates (i.e., CLK and C̅L̅K̅ alternate repeatedly), Vout continues to increase in equal or substantially equal steps approaching Vcc. Eventually, after a number of cycles, Vout reaches Vcc and operation of the load circuit(s) may begin. When this occurs, switches 206 and 208 continue to cycle, selectively coupling the capacitor 202 to Vref and Vout, allowing Vcc to provide power to the load(s) via the circuit 200. The feedback from Vout causes MP1 to turn off or substantially turn off (i.e., operate in the cutoff region), which causes the source-gate voltage to drop to 0 V. Thus, Vref and Vout will maintain the constant or substantially constant voltage of Vcc instead of increasing at each cycle.

As an alternative to powering the load circuit(s) by repeatedly cycling the switches 202 and 204 after Vout reaches Vcc, any or all of the circuit 200 may be bypassed, including the capacitors 202 and/or 204, the switches 206 and/or 208, the current source 210, and/or the field-effect transistor MP1 to couple Vcc directly to the load(s) via some other means (not shown). Another option to power the load(s) may be to close both switches 206 and 208 and deactivate or bypass the current source 210, allowing any required load current to flow directly from Vcc to Vout via the switches 206 and 208.

As shown in FIG. 2, the example capacitor 202 has a capacitance value of C and the example capacitor 204 has a capacitance value of nC, which is n times the capacitance of the capacitor 202, where n may be an integer or a non-integer. The charge conservation equations for the circuit 200 are shown in equations (1) and (2). Equation (1) shows the charge equation while the CLK signal is active (i.e., switch 206 is closed and switch 208 is open):

Q=C*(Vout′+Vsg)+nC*Vout′ (1)

Equation (2) shows the charge equation while the C̅L̅K̅ signal is active (i.e., switch 206 is open and switch 208 is closed):

Q=(n+1)C*Vout (2)

wherein Q is the total charge, Vout′ is the output voltage for the previous (or current) cycle, Vout is the output voltage for the subsequent cycle, and Vsg is the source-gate voltage of MP1. Using equations (1) and (2), equations (3) and (4) can be derived:

Vout′+Vsg+n*Vout′=(n+1)Vout (3)

Vout−Vout′=Vsg/(n+1) (4)

Equation 4 shows that the voltage step size can be controlled by defining appropriate values for the source-gate voltage for MP1 and/or the capacitance ratio for the capacitors 202 and 204. Equation 4 also illustrates that the voltage step size is independent of the absolute value of Vout, assuming that the source-gate voltage of MP1 and the capacitance ratio of the capacitors 202 and 204 remain constant.

FIG. 3 is a graph illustrating a voltage-time relationship for the circuits 100 and 200 of FIGS. 1 and 2. A first trace 302 illustrates an example soft-start ramp output for the circuit 100 as shown in FIG. 1. As shown from the trace 302 and described above, the voltage increases are largest at the start of the ramp (i.e., the left side or lowest time value) and decrease with each subsequent cycle or step until the output (i.e., Vout) reaches the value of the input (i.e., Vref). That is, the trace 302 follows an RC time constant charging profile. A second trace 304 illustrates an example soft-start ramp output for the circuit 200 illustrated and described in connection with FIG. 2. As shown in the trace 304 and described above, each voltage step along the trace 304 is equal or substantially equal.

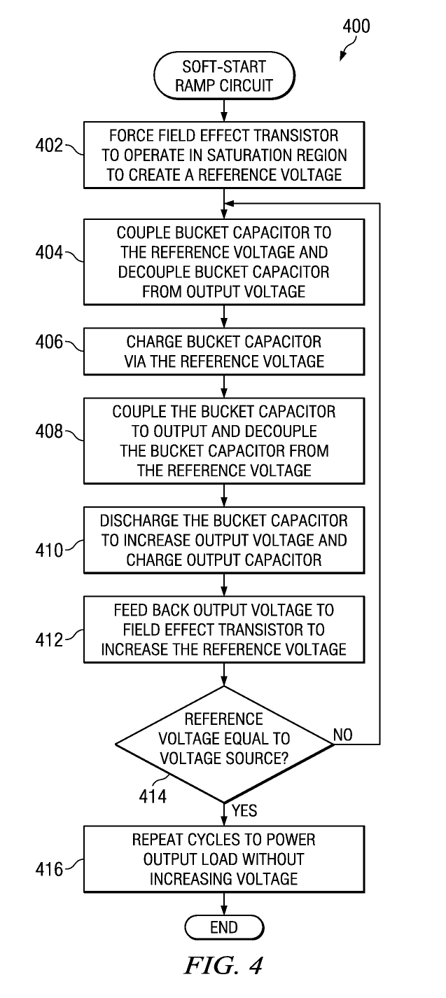

FIG. 4 is a flowchart illustrating an example process 400 to provide a circuit with a switched-capacitor soft-start ramp. The method 400 may be used to describe the operation of the circuit 200 illustrated and described in connection with FIG. 2. The circuit 200 begins operation when a voltage source (e.g., Vcc) is connected to provide power to a load (e.g., Vout). A current source (e.g., the current source 210) generates and maintains a current to force a field-effect transistor (e.g., the PMOS MP1) to operate in the saturation region (block 402). Next, switches (e.g., switches 206 and 208) couple a bucket capacitor (e.g., the capacitor 202) to a reference voltage (e.g., Vref) and decouple the bucket capacitor from the output voltage (block 404). While coupled, the bucket capacitor is charged via the reference voltage (block 406). After a time period has elapsed or, alternatively, the bucket capacitor is sufficiently charged, the switches decouple the bucket capacitor from the reference voltage and couple the bucket capacitor to the output capacitor and, accordingly, the output voltage (block 408). When this occurs, the bucket capacitor is discharged to increase the output voltage and charge an output capacitor (e.g., the capacitor 204) coupled to the output voltage (block 410). The blocks 404-410 may be considered one cycle.

The output voltage feeds back to the field-effect transistor (e.g., to the gate of MP1), causing the reference voltage to increase accordingly (block 412). For example, in the circuit 200 of FIG. 2, Vref is greater than Vout by a margin of the source-gate voltage of MP1. If the reference voltage remains less than that of the voltage source (block 414), control may revert back to block 404 to start another cycle. The method may iterate in this way to increase the output voltage from a beginning voltage to a desired voltage (i.e., the voltage source). If the reference voltage is increased by the feedback to have a voltage equal to the voltage source (block 414), the circuit 200 continues to cycle (i.e., repeat blocks 404-410) even though the output voltage does not increase (block 416). The capacitor is charged and discharged to deliver current to the output voltage and output capacitor.

After the output voltage has ramped up, as an alternative to repeating the cycles, the method 400 may bypass any or all of the components in the circuit 200 (e.g., the current source, the switches, the capacitors or the field-effect transistor) to couple the voltage source directly to the output via an additional circuit. A third option to power the load may be to close both switches and deactivate the current source, allowing any required load current to flow directly from the voltage source to the output.

Although certain methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. An apparatus to provide a soft-start voltage, comprising;
a first capacitor;
a feedback circuit to increase a reference voltage based on an output voltage;
a second capacitor, having a capacitance value greater than a capacitance value of the first capacitor;
a first device to couple and decouple the first capacitor to the reference voltage; and
a second device to couple and decouple the first capacitor to the second capacitor.

2. An apparatus as defined in claim 1, wherein the feedback circuit comprises a field-effect transistor.

3. An apparatus as defined in claim 2, wherein the feedback circuit further comprises a current source.

4. An apparatus as defined in claim 3, wherein the current source forces the field-effect transistor to operate in a saturation region.

5. An apparatus as defined in claim 2, wherein the increase in output voltage is further based on a source-gate voltage of the field-effect transistor.

6. An apparatus as defined in claim 1, wherein the reference voltage is the result of the sum of the output voltage and a feedback voltage.

7. An apparatus as defined in claim 1, wherein the first capacitor increases the output voltage.

8. An apparatus as defined in claim 1, wherein the first device selectively couples the first capacitor to the reference voltage based on one or more periodic signals.

9. An apparatus as defined in claim 1, wherein the second device selectively couples the first capacitor to the second capacitor based on one or more periodic signals.

10. An apparatus as defined in claim 1, wherein an increase in output voltage is based on the first capacitance value and the second capacitance value.

11. An apparatus as defined in claim 1, wherein the first device and the second device are complementary metal-oxide-semiconductor field effect transistors.

12. A method for providing a circuit with a soft-start voltage ramp, the method comprising:
selectively coupling a capacitor to a reference voltage and an output;
charging the capacitor via the reference voltage;
increasing an output voltage by discharging the capacitor; and
increasing the reference voltage based on the output voltage.

13. A method as defined in claim 12, further comprising coupling a voltage supply to the output voltage.

14. A method as defined in claim 12, further comprising bypassing at least one of the capacitor or a feedback circuit in response to the output voltage.

15. A method as defined in claim 12, further comprising simultaneously coupling the capacitor to the output voltage and the reference voltage.

16. A method as defined in claim 12, further comprising forcing a field-effect transistor to operate in a saturation region.

17. A method as defined in claim 12, wherein the output voltage is increased based on the voltage of a feedback circuit.

18. A method as defined in claim 12, wherein the capacitor is coupled to one of the reference voltage or the output voltage based on a periodic signal.

19. A soft-start voltage ramp circuit, comprising:
a first capacitor;
a second capacitor coupled to an output to store charge;
a first device to couple and decouple the first capacitor to a reference voltage based on a first periodic signal;
a second device to couple and decouple the first capacitor to the second capacitor based on one of the first periodic signal or a second periodic signal; and
a feedback circuit to provide feedback from the output to the reference voltage, wherein the reference voltage is the sum of a voltage at the output and a second voltage associated with the feedback circuit.

20. A soft-start voltage ramp circuit as defined in claim 19, wherein the first device and the second device are complementary metal-oxide-semiconductor field effect transistors.

21. An apparatus as defined in claim 19, wherein the feedback circuit comprises a field-effect transistor.

22. An apparatus as defined in claim 19, wherein the feedback circuit further comprises a current source.

23. A soft-start voltage ramp circuit, comprising:
a first capacitor;
a second capacitor coupled to an output to store charge;
a first device to couple and decouple the first capacitor to a reference voltage based on a first periodic signal;
a second device to couple and decouple the first capacitor to the second capacitor based on one of the first periodic signal or a second periodic signal;
a p-channel field-effect transistor to provide feedback from the output to the reference voltage, wherein the reference voltage is the sum of an output voltage and a source-gate voltage of the transistor; and
a current source to force to the transistor to operate in the saturation region.

24. A soft-start voltage ramp circuit as defined in claim 23, wherein the first device and the second device are complementary metal-oxide-semiconductor field effect transistors.
